(19) United States
(12) Patent Application Publication
(10) Pub. No.: US 2009/0005948 A1
(43) Pub. Date: Jan. 1, 2009

(54) LOW SPEED FOLLOW OPERATION AND CONTROL STRATEGY

(76) Inventors: Faroog Abdel-kareem Ibrahim, Dearborn Heights, MI (US); Gerald L. Sielagoski, St. Claire Shores, MI (US)

Correspondence Address: VISTEON/BRINKS HOFER GILSON & LIONE, 524 South Main Street, Suite 200, Ann Arbor, MI, 48104, US

(21) Appl. No.: 11/770,039

(22) Filed: Jun. 28, 2007

(51) Int. Cl. B60W 30/16

(52) U.S. Cl. 701/96

(57) ABSTRACT

A system for the low speed following of a target vehicle. The system includes a sensor to detect data on the target vehicle and a controller to adjust operational parameters of the host vehicle in a low speed following mode. The sensor is configured to detect the target vehicle and determine the distance and/or speed of the target vehicle. Based on the detected data, the controller may adjust host vehicle's operating parameters, such as acceleration. This is done if the host vehicle speed is below a predefined vehicle speed and the distance to the target vehicle is below a predefined upper limit. The controller may be configured to maintain a predefined following distance from the target vehicle based on the host vehicle speed and the distance to the target vehicle.

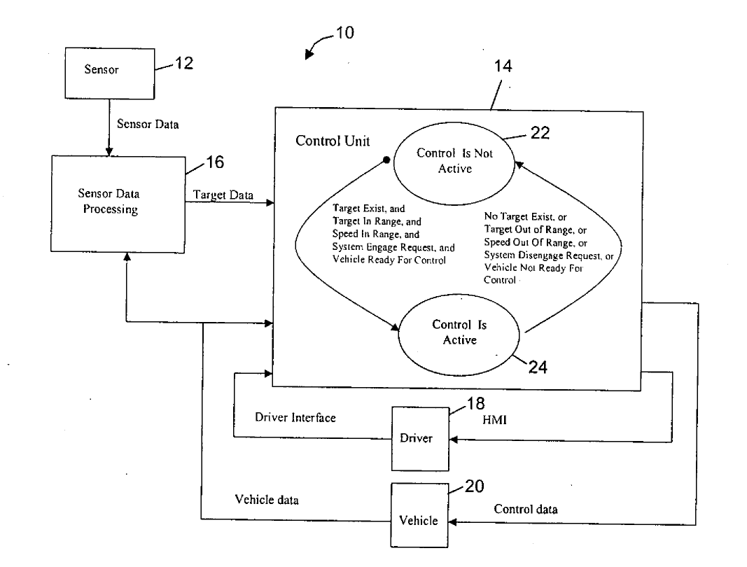

### BACKGROUND

1. Field of the Invention

The present invention generally relates to a system for following a target vehicle. More specifically, the system relates to a low speed following system.

2. Description of Related Art

In the automotive industry, sensing systems have been applied to automatic cruise control (ACC) systems. ACC systems are designed for use on the roadways where traffic is very light or non-existent and use sensors, often radar sensors, to sense object ahead of the vehicle. The ACC system may maintain the host vehicle at a constant speed, often between 55 and 65 miles per hour. Further, the ACC system may be configured to disengage based on the upcoming road geometry or to maintain a minimum following distance for the host from a preceding or target vehicle. While ACC systems ease the workload on drivers during a long monotonous drive with very little traffic, they do not address the problems associated with very congested slow speed traffic scenarios.

### SUMMARY

Overcoming the enumerated drawbacks and other limitations of the related art, the present invention provides a low speed following (LSF) system. The LSF system controls throttle and brake parameters in low speed traffic conditions. Having a LSF system in a vehicle decreases the driver's workload in an extended period of congested, low speed traffic.

The LSF system may include a sensor to detect data on the target vehicle and a controller to adjust vehicle parameters in a low speed following mode. The sensor may include a vision sensor or radar sensor configured to detect the target vehicle and determine the range and/or speed of the target vehicle. Based on the detected data, the controller may adjust host vehicle parameters, such as requested acceleration, if the host vehicle speed is below a predefined vehicle speed and the range of the target vehicle is below a predefined range. As such, the controller can maintain a predefined distance from the target vehicle based on the host vehicle speed and the range of the target vehicle.

The controller may automatically disable the low speed following mode if the range of the target vehicle becomes greater than the predefined range or the speed of the host vehicle becomes greater than the predefined vehicle speed. As such, the controller will coordinate with the vehicle control unit and the driver interface unit to provide a smooth transition from the active low speed following mode to the inactive low speed following mode.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

The figure is a schematic illustration of a system for following a target vehicle and embodying the principles of the present invention.

### DETAILED DESCRIPTION

As seen in the figure, a system 10 for the low speed following of a target vehicle is provided. The system 10 includes a sensor 12, a sensor data processing module 16, and a control unit 14.

The sensor may be a vision or other sensor to detect the distance between the host vehicle (the vehicle that is equipped with the system) and the target vehicle (the closest in-lane vehicle). Examples of a vision sensor include, without limitation, a camera such as a black and white or color CCD sensor. Sensor 12 may alternatively be a radar sensor including, for example a laser based radar system. Other range based sensors, including optical sensors, acoustical sensors or combinations thereof, may also be used. The sensor 12 provides sensor data to the sensor data processing module 16. This sensor data may be image data for the vision sensor or range and signal strength data for a radar type sensor.

The sensor data processing module 16 receives the data and evaluates the image or other data to generate target data relating to the characteristics of the target vehicle. The target data may include whether a target vehicle has been detected, the range of the target vehicle, the speed of the target vehicle, the acceleration of the target vehicle, and/or the relative speed and acceleration between the target vehicle and the host vehicle. The resulting target data is then provided from the sensor data processing module 16 to the control unit 14.

The control unit 14 provides control data to the vehicle control unit 20, which interacts with other vehicle control systems, including the engine control unit (not shown), to vary the acceleration or speed of the vehicle according to the provided control data. The control data may therefore include information such as a requested acceleration, a requested speed, or other commonly used vehicle control data. The vehicle control unit 20 also provides vehicle control data to the control unit 14 and sensor data processing module 16. This data may include current vehicle speed, current vehicle acceleration, braking data, gear status and potentially vehicle stability data. Since the sensor 12 is attached to the host vehicle, the data from the sensor 12 is generally indicative of relative information between the host vehicle and the target vehicle. Therefore, the sensor data processing module 16 may utilize the host vehicle speed and other data, from the vehicle control unit 20, to generate non-relative speed or acceleration information on the target vehicle.

The control unit 14 is also in communication with a driver interface unit 18 that provide driver interface control signals to the control unit 14. The driver interface control signals may indicate a variety of request actions, such as that the driver has requested activation of the low speed following mode or that the driver has requested deactivation of the low speed following mode. Accordingly, the driver interface unit 18 provides the driver interface signals, such as a low speed following mode engage/disengage signal, to the control unit 14.

The control unit 14 operates in two low speed following modes, an active mode 24 and an inactive mode 22. The control unit 14 is configured to switch between the low speed following active and inactive modes based on a number of criteria. Some of the criteria that may be considered may include whether the target is detected, whether the target is within a predetermined range, whether the host vehicle is below a predetermined speed, whether the driver has requested that the low speed following system be engaged, and whether the vehicle control unit 20 is ready to receive control data from the control unit 14. As such, in one embodiment, the control unit 14 switches from the inactive mode 22 to the active mode 24 if:
the target is detected; and
the target is closer than a predefined range, and
the host speed is less than a predefined speed; and
the driver has requested the low speed following system to engage; and
the vehicle control unit 20 is ready to receive control data from the control unit 14.

Similarly, the control unit 14 is configured to switch from the low speed following active mode 24 to the inactive mode 22 if:
the target vehicle is not detected; or
the target vehicle is further than a predefined range from the host vehicle; or
the speed of the host vehicle is greater than a predefined speed; or
the driver requests disengagement of the low speed following system; or
the vehicle control unit 20 is not ready to receive control data from the control unit 14.

When the driver activates the LSF system 10, the host vehicle will follow the target vehicle. Via throttle and brake control, the LSF system 10 uses the target vehicle range measurement and the host vehicle speed to maintain a predefined distance from the target vehicle.

Because the system 10 is designed for low speed following conditions, the typical operational speed of the system 10 is up to about 25 mph, while the typical operational range is up to about 30 m. When the speed or the range measurements are out of the operational range or there is no target vehicle, the system is automatically deactivated. It is also deactivated when the driver brakes or deactivates the system. In the case of automatic deactivation, the control is smoothly handed back to the driver. In case of deactivation due to driver intervention, such as braking, control of the vehicle is immediately handed back to the driver.

The LSF system 10 is different from an ACC system in its usage of environment, speed, range, system operation, and longitudinal control. An ACC system is typically used with flowing or no traffic. If the driver is in congested, low speed traffic, the driver may decide to use the LSF system 10. The LSF system 10 is activated by using a system activation button on the driver interface unit 18. The control unit 14 then transfers the system 10 between the inactive mode and the active mode based on the target data, vehicle speed, and status of the vehicle (example: the gear position). Accordingly, the control unit 14 will control the following distance between the host vehicle and the target vehicle. The control unit 14 maintains the following distance by sending the control data (example: torque and brake/throttle status) to the vehicle control system 20. If the target vehicle leaves the host lane, the target data sent from the processing unit 16 to the control unit 14 will show that there is no vehicle in the host lane. The control unit 14 the transfers the system from the active mode to the inactive mode by slowly reducing the requested acceleration. Before the system 10 completely hands control back to the driver, the control unit 14 informs the driver, through the driver interface 18, that the system 10 is no longer active. The driver interface 18 may inform the driver through an audible alert, such as a beep, or a visual alert such as a flashing light.

The LSF system 10 generally operates at low speeds and short ranges. As such, the low speed requirement allows for a relaxation in the update rate compared to many automotive control systems, while the short range requirement pushes for an aggressive control strategy. In addition, congested traffic (stop and go traffic) generally causes drivers to apply a high deceleration and a high acceleration force requiring a wide range of control authority. Also, in congested driving conditions, the driver often switches between brakes and throttle very frequently, requiring for a fast and smooth control of the vehicle acceleration.

Based on the above requirements, one implementation of a control strategy may include a minimum update rate for the system at about 10 Hz. The acceleration range for the system may be set at between −4 m/sec² to 2.5 m/sec². Meanwhile, the expected range accuracy is the maximum of 0.5 m and 0.05*Range, while the expected vehicle speed accuracy is about 0.5 m/sec. Based on these parameters the system generates a requested acceleration signal that can be provided to the vehicle control unit 20. As such, the requested acceleration may be generated based on the relationship:

Requested Acceleration=A*(Range−(a*Speed+do))+B*Relative_Velocity+C*Host_Acceleration+D*Target_Acceleration+E*Target Deceleration.

As noted above, the LSF operation requires an aggressive control strategy and, at the same time, a stable one. Therefore, the gains A, B, C, D, and E of the above equation are adaptable based on the evaluated relative motion between the host vehicle and the target vehicle. Also, the headway “a” is a function of speed to discourage cut-in. The “do” offset is to accommodate a zero speed condition. Range is the distance from the host vehicle to the target vehicle; speed is the velocity of the host vehicle; Relative_Velocity is the difference between the velocity of the host vehicle and the target vehicle; Host_Acceleration is the acceleration of the host vehicle; Target_Acceleration is the acceleration of the target vehicle; and Target_Deceleration is the deceleration of the target vehicle. The selection of the gains at any time provides the driver with the right throttle or brake control. The arbitration between throttle and brake is designed to mimic the expected driver action. Therefore, the selection of the gain values is more than a simple control law, but has to account for some human factors as well.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

We claim:

1. A system for allowing a host vehicle to follow a target vehicle, the system comprising:
a sensor configured to detect data from the target vehicle;
a controller configured to adjust host vehicle operating parameters in an active following mode based on the data when host if a vehicle speed is below a predefined vehicle speed and distance to the target vehicle from the host vehicle is below a predefined upper limit.

2. The system according to claim 1, wherein the controller is configured to maintain a predefined distance from the target vehicle based on the host vehicle speed and the distance to the target vehicle.

3. The system according to claim 1, wherein the controller is configured to change from the active following mode to an inactive following mode if the distance to the target vehicle becomes greater than the predefined upper limit.

4. The system according to claim 1, wherein the controller is configured to change from the active following mode to an inactive following mode if the host vehicle speed becomes greater than the predefined vehicle speed.

5. The system according to claim 1, wherein the controller is configured calculate a requested acceleration.

6. The system according to claim 5, wherein the vehicle requested acceleration is calculated based on the distance to the target vehicle, the host vehicle speed, a host vehicle acceleration, a target vehicle speed, a target vehicle acceleration, and a target vehicle deceleration.

7. The system according to claim 6, wherein the vehicle requested acceleration is calculated based on the relationship:
Requested Acceleration=A*(Range−(a*Speed+do))+B*Relative_Velocity+C*Host_Acceleration+D*Target_Acceleration+E*Target Deceleration
where speed is the velocity of the host vehicle; Relative_Velocity is the difference between the velocity of the host vehicle and the target vehicle; Host_Acceleration is the acceleration of the host vehicle; Target_Acceleration is the acceleration of the target vehicle; Target_Deceleration is the deceleration of the target vehicle; A, B, C, D, and E are adaptable gains based on the evaluated relative motion between the host vehicle and the target vehicle; a is a function of speed to discourage cut-in; and do is an offset to accommodate a zero speed condition.

8. A method for following a target vehicle by a host vehicle, the method comprising the steps of:
determining a distance to the target vehicle;
determining a host vehicle speed;
determining if the distance is below a predefined upper limit;
determining if the host vehicle speed is below a predefined vehicle speed;
adjusting host vehicle operating parameters in an active following mode if the host vehicle speed is below the predefined vehicle speed and the distance to the target vehicle is below the predefined upper limit.

9. The method according to claim 8, further comprising maintaining the host vehicle at a following distance from the target vehicle based on the host vehicle speed and the distance to the target vehicle.

10. The method according to claim 8, further comprising changing from the active following mode to an inactive following mode if the distance becomes greater than the predefined upper limit.

11. The method according to claim 8, further comprising changing from the active following mode to an inactive following mode if the host vehicle speed becomes greater than the predefined vehicle speed.

12. The method according to claim 8, further comprising calculating a requested acceleration.

13. The method according to claim 12, wherein the vehicle requested acceleration is calculated based on the distance to the target vehicle, the host vehicle speed, a host vehicle acceleration, a target vehicle speed, a vehicle acceleration, a target vehicle acceleration, and a target vehicle deceleration. The calculation of the requested acceleration is not necessarily limited or constrained to only the use of these parameters.

14. The method according to claim 13 wherein the vehicle requested acceleration is calculated based on the relationship:
Requested Acceleration=A*(Range−(a*Speed+do))+B*Relative_Velocity+C*Host_Acceleration+D*Target_Acceleration+E*Target Deceleration
where speed is the velocity of the host vehicle; Relative_Velocity is the difference between the velocity of the host vehicle and the target vehicle; Host_Acceleration is the acceleration of the host vehicle; Target_Acceleration is the acceleration of the target vehicle; Target_Deceleration is the deceleration of the target vehicle; A, B, C, D, and E are adaptable gains based on the evaluated relative motion between the host vehicle and the target vehicle; a is a function of speed to discourage cut-in; and do is an offset to accommodate a zero speed condition.
